(19) United States
(12) Patent Application Publication
(10) Pub. No.: US 2014/0012600 A1
(43) Pub. Date: Jan. 9, 2014

(54) METHOD OF PREVENTING PRESCRIPTON ABUSE

(71) Applicant: PRESCRIPTION DIVERSION SOLUTIONS, INC., COSTA MESA, CA (US)

(72) Inventors: JUSTIN DOMESEK, COSTA MESA, CA (US); KHYBER ZAFFARKHAN, NEWPORT BEACH, CA (US); SCOTT MARTIN, ALISO VIEJO, CA (US)

(21) Appl. No.: 13/936,469

(22) Filed: Jul. 8, 2013

Related U.S. Application Data
(60) Provisional application No. 61/668,964, filed on Jul. 6, 2012.

(51) Int. Cl. G06F 19/00

(52) U.S. Cl. CPC G06F 19/3456
USPC 705/3

(57) ABSTRACT

A computer-implemented system for preventing prescription abuse. The system includes a secure login for both physicians and pharmacists. A prescribing physician submits a prescription request to the system after selecting an intended patient, after which the system generates a unique prescription code derived from the patient history and prescription medication request. The physician is able to include this unique code on the prescription, thereby allowing a pharmacist to ensure the prescription has not been tampered with.

### CROSS-REFERENCE TO RELATED APPLICATIONS

This application claims the benefit of U.S. Provisional Application No. 61/668,964, filed on Jul. 6, 2012, the teachings of which are expressly incorporated by reference.

### STATEMENT RE: FEDERALLY SPONSORED RESEARCH/DEVELOPMENT

Not Applicable

### BACKGROUND

Prescription drug abuse is the intentional use of a prescription medication in a manner other than it was prescribed for the experience of euphoria, disassociation, or relief from anxiety. Prescription drug abuse started in America with the use of laudanum, a combination of opium and alcohol, as a remedy for pain, diarrhea, insomnia, chronic cough, and anxiety. However with the start of the American Civil War, there was a need for quicker, stronger, and more effective pain medications in pill form to treat soldiers inflicted with saber, gunshot, and shrapnel wounds. As such, the commercial manufacturing of morphine in pill form began around 1827 in Germany. The Bayer Company in Germany began producing heroin in pill and liquid form in 1898 in part as a remedy for morphine addiction, and as a more effective oral treatment for pain. As the availability and distribution of oral narcotics increased, so too did the number of addicts.

With increasing numbers of patients addicted to narcotics, the overdose death toll began to rise. As such in 1906 the Pure Food and Drug Act mandated that all ingredients must be labeled on every prescription medication. The Harrison Narcotic Tax Act followed this law closely in 1914, bringing all addictive narcotic substances under the control of a licensed physician, and requiring a prescription for their distribution to patients.

Between 1991 and 2010, prescriptions for opioid analgesics increased from about 75.5 million to over 1 Billion. By 2010, over 7 million U.S. citizens met the medical criteria for prescription drug abuse, with 5.1 million of these users abusing pain medications. In the state of California alone, over 300 million narcotic prescriptions were filled by pharmacies in 2012. Today, prescription drug abuse accounts for over 33,500 deaths annually. In fact, every 19 minutes a man, woman, or youth overdoses and dies from prescription drugs. The reasons are twofold: dire misperception about prescription medication safety and dramatically increased availability.

The cost of narcotic use and abuse to the United States has been staggering. Prescription drug abuse is costing taxpayers more than $100 billion each year in frivolous medications, Emergency Room visits and treatments for overdose. Hospitals, treatment centers, and medical clinics have been overwhelmed with the dramatic increase in activity from prescription drug abuse. In 2008 more than 305,000 Americans were taken to the Emergency Room for prescription drug overdoses. In 2009, that number grew to more than 475,000 visits, and in 2010 Emergency Room visits for prescription drug abuse exceeded 1.3 million. That is a 400% growth in just three years.

The staggering cost for Emergency Room visits, overdose treatments, and physician office visits related to prescription drug abuse threatens the solvency of healthcare systems. WellPoint, Inc., the largest commercial healthcare provider in the United States, reported paying $41 in related claims for every $1 it paid in narcotic prescriptions for suspected “doctor-shoppers,” individuals that visit several doctors complaining of a wide array of ailments in order to obtain multiple prescriptions.

In addition to the many types of overdose treatments, insurers are burdened with the cost of medications, many of which are not being used for medical purposes. According to the Coalition Against Insurance Fraud, a single prescription drug abuser who “doctor shops” costs insurance companies in the U.S. between $10,000 and $15,000 per person.

The primary methods of prescription diversion are via doctor shopping and prescription fraud. Doctor shopping is the most prevalent method in urgent care centers and emergency departments where patients are from varied locales. Many emergency rooms and urgent care clinics do not have the resources to profile all patients and check their prescription drug activity, making them easy targets. Some individuals using this tactic actually suffer from a legitimate illness but continue to visit many doctors to stockpile medications for non-medical consumption and to resell for huge profits.

Prescription fraud is another common tactic used to obtain controlled medications and occurs frequently in the medical practice setting by altering valid prescriptions or stealing blank pads to write fake prescriptions; forged prescriptions can also be reproduced on high-quality laser printers. Often the telephone number on the prescription is altered to that of the forger so the forger can confirm that the prescription is legitimate should the pharmacist call to verify that the doctor actually wrote it. Individuals impersonating a doctor or his or her office staff may attempt to obtain illegal prescriptions by calling in a prescription to an unsuspecting pharmacist. This is often done when the real doctor's office is closed, to avoid detection. Altering a prescription to increase the dosage, number of pills dispensed, or the number of refills is another way that individuals obtain illegal prescriptions. For many years forgers have used correction fluid to blot out the ink on prescriptions they wanted to change. They would take the original valid prescription to a photocopier, and produce what appears to be a blank prescription. However the more popular method today is to use acetone to remove the ink of ball-point pens from paper. Individuals use acetone to “wash” the prescription, which means the chemical is only used to eliminate the drug they want to change, leaving the doctor's signature intact. The sought-after drug is then written on the altered prescription, often with no one the wiser, including the pharmacist who ultimately dispenses the drugs.

In an effort to combat the rising tide of narcotic use, overdose and associated risk for healthcare providers, states initiated the use of Prescription Drug Monitoring Programs (PDMP). A PDMP is an online tool that can be used to screen patients for prescription diversion and abuse. PDMP's were intended as a patient care tool, drug diversion program, and insurance fraud investigative tool. The effort was to help prescribers avoid drug interactions and identify drug□seeking behaviors or “doctor-shopping” (visiting multiple prescribers to obtain prescription drugs for non-medical purposes).

Currently, 35 states have operational PDMPs, and 11 additional states and 1 U.S. territory have passed legislation authorizing the development of a PDMP. Because not all states have a PDMP, and because data sharing and interoperability between states does not exist, the full benefit of PDMPs has not been realized. PDMPs are electronic databases intended to track prescriptions of controlled substances dispensed in the state. They pull prescription information from the pharmacy databases and distribute it to individuals who are authorized under state law to receive the information for purposes of their profession (i.e. physicians and pharmacists). Each PDMP is housed by a specified statewide regulatory, administrative or law enforcement agency, however each PDMP is managed by different governing bodies which creates inconsistency. Another PDMP discrepancy is in the manner and frequency that the data is collected among states. The inconsistency in state laws and the lack of accurate and accessible information has resulted in poor compliance, and in turn an ineffective solution. In 2012 states began reviewing PDMP data to determine its effectiveness and whether the program is worth continuing to fund. California's PDMP has been defunded to poor adoption rates and budgetary constraints. In addition to the lack of communication between PDMPs, there is a substantial information gap between health care providers using paper charts and those using Electronic Health Records; and there is an additional gap between the time a narcotic prescription is generated and the time the prescription is filled at the pharmacy level.

There has been an increasing trend in the use of Electronic Medical Records. To date there are over 550 proprietary Electronic Health Records in the United States, and none of them are able communicate with each other. This allows for three high-risk scenarios: drug interactions, doctor-shopping, and duplication of prescriptions among multiple healthcare providers. All of these scenarios increase the likelihood of a narcotic-related patient overdose.

Prescription drug diversion can occur at the provider (doctor) level and the pharmacy level, and therefore the likelihood of occurrence is magnified. Whether altering their behavior and medical history, or altering the prescription itself, fraud and diversion can appear in many forms and has become extremely prevalent.

All current solutions fail to provide a proactive approach to curtailing prescription drug abuse. They have proven unable to identify problem patients and problem practitioners in the early stages of abuse. Even when diversion is suspected and prescriptions are denied, abusers are recycled back into the system with the opportunity to exploit other physicians and continue this costly process. The lack of a resources and inefficient solutions are costing insurers over 100 billion dollars each year in medications and treatments in addition to an immeasurable cost of processing and managing the high number of bogus prescription drug claims.

As such, there is a need in the field for a solution that allows for real time collaboration between all licensed health prescribers between doctors offices, among different health systems, and across state lines. There is further a need for a system that aids in the prevention of narcotic use, abuse, divergence, and doctor shopping by gathering prescription information at the source, the point of prescribing. There is a need for a system that utilizes an automated prescribing function that is linked to the electronic Food and Drug Administration national code directory to prevent medication errors. This includes medications, dosages, and routes of administration. Additionally, there is a need for a system that generates a printed prescription on tamper-proof, watermarked, sequentially-coded and batched prescription paper. There is a need for this system to establish the validity of a physician generated prescription by combining patient information into a unique identifier that may be encoded into a scannable code and applied to every prescription. The scannable code is generated at the provider level, and verified at the pharmacy level to ensure each prescription filled is exactly as it was written by the medical provider. There is further a need for the system to grant Health Systems, Medical Malpractice Companies, and Insurance companies the ability to effectively monitor prescription drug activity and fetter out doctor-shoppers and negligent medical providers.

### BRIEF SUMMARY

State-run monitoring programs were intended to help curtail doctor shopping, but the lack of timely and accurate information has deterred physicians from using these systems on a daily basis. In the state of California, there are over 169,000 medical doctors. The California PDMP is accessed by less than 5% of all medical providers in the State of California. The system described in one embodiment herein, however, provides real-time, accurate data, and is capable of tracking each doctor-patient interaction of all registered users. The information is immediate and available to all registered physicians as soon as they log into the system. This information allows them to make more informed decisions and protect their professional integrity, their patients, and their medical license.

Since payors do not have access to PDMP or real-time prescription data, they are forced to fight prescription drug abuse retroactively through claims matching and auditing. These strategies have significant challenges because many of the claims databases do not interface with one another. There are many different pharmacy benefit management companies who control this data and it is available in different formats that are difficult to analyze (there are 70 different pharmacy benefit management companies in the United States). With more than 12 billion claims to review and adjudicate each year, payors are simply overwhelmed and need a solution to maximize their resources and reduce the number of fraudulent claims submitted.

One embodiment described herein may help healthcare systems more effectively utilize their resources and increase productivity and profit. By mitigating the risk of prescription transactions and streamlining claims reviews, valuable resources can be allocated to satisfy other areas of need.

Embodiments of the present disclosure may offer the healthcare industry a reduction in spending through expediting and improving the prescription validation process and reducing the need for claims review. Increased savings will allow insurers to offer lower premiums and in turn recruit more members. Commercial organizations will pay less to subsidize healthcare premiums for their employees; Emergency Rooms and Urgent Care clinics will be less crowded with patients seeking narcotics and suffering from abuse; doctors will have more control of patient treatments and in turn patient results; new system controls will deter fraudulent behavior and ensure the safety of patients. The ability to more easily identify the “problem patients” and “problem practitioners,” and foresight to take punitive action will better protect bottom lines and patient lives.

Embodiments of the present disclosure include a comprehensive prescription management tool that combines the following:
Real time collaboration between all licensed health prescribers between doctors' offices, among different health systems, and across state lines.
Prevention of narcotic use, abuse, divergence, and doctor shopping by gathering prescription information at the source, the point of prescribing.
An automated prescribing function that is linked to the electronic Food and Drug Administration national code directory to prevent medication errors. This includes medications, dosages, and routes of administration.
A printed prescription on tamper-proof, watermarked, sequentially-coded and batched prescription paper. The batch number on each prescription is able to be easily traced back to the prescribing
The verification and authenticity of a prescription that combines every patient's name, date of birth, and zip code into a unique identifier which is encoded into a scannable code and applied to every prescription. The scannable code is generated at the provider level, and verified at the pharmacy level to ensure each prescription is filled exactly as it was written.
The real-time patient and provider activity reports that allow clinically and financially responsible organizations to effectively monitor prescription drug activity and fetter out doctor-shoppers and negligent medical providers.

The present, HIPAA-compliant solution allows payors to standardize prescriptions and track prescription drug activity in real-time. A centralized database tracks essential medication details and diagnosis codes for each prescription at the point of care, and offers treating physicians transparent communication with other providers. This real-time information allows providers to make better decisions and prevent patients from doctor shopping. Prescriptions may be printed with a unique identifier on 8½×11 tamper-resistant prescription paper to prevent patients from committing prescription fraud.

The content, organization, and transparency of the data helps identify problem patients and problem practitioners. The present invention offers payors (Workers' Compensation Carriers, Self-Insured Companies, Third Party Administrators, Pharmacy Benefit Managers, and Private Insurance Companies) increased protection from the cost of unnecessary medications, avoidable Emergency Room visits, and treatments for prescription drug abuse. The present invention further offers healthcare organizations cost containment, increased prescription security, and improved communication among providers, while also offering physicians reduced prescription times, reduced pharmacy callbacks, and reduced risk in prescribing controlled substances.

The web-based application prevents prescription drug diversion and enhances total quality management of providers. The system includes a real-time, transparent database that allows physicians and pharmacists to monitor all prescription drug activity and verify all controlled medication requests. It tracks every doctor-patient encounter that generates a prescription for controlled medication. Each time a controlled medication is requested, the date and time, drug name, form, strength, quantity, provider DEA#, and diagnosis code is entered and immediately updated to a secure database where it can be viewed by other physicians and pharmacists (with a valid membership). The accessibility and accuracy of this information is critical to all providers who write or fill prescriptions for controlled medications. This information allows providers to verify what medications the patient has received, who prescribed them, and when the prescription was written and filled.

A comprehensive activity report may be provided to insurers to allow them to monitor physicians prescribing habits and evaluate whether a prescription drug claim is credible. Diagnosis code reimbursement has been an established payer model for the past 25 years, however it is quite easy to manipulate reimbursement by “up coding” patient care. It is common for unethical medical providers to assign a diagnosis of 199.0 or malignancy related pain to healthy patients only to sell them prescriptions. The present system allows every insurer, as well as Medicare programs, the ability to audit a provider's records especially when there is a trend of high pill quantities and high dose narcotics all coming from a single provider. With established pay for performance models in place, fraudulent billing and prescription dispensing would not disqualify that provider for case specific reimbursement, but insurers would have the ability to remove “problem” practitioners from their provider list. Insurers, Medicare and Medicaid would save billions of healthcare dollars every year with the diagnosis verification.

The end users of this system are envisioned to be pharmacists and doctors. On initial sign up, a user's information is recorded. Doctors DEA numbers may be verified to be valid using a checksum and NPI numbers are verified with the Luhn algorithm. Since pharmacists do not have DEA numbers they are not recorded for that type of user. After registering, the user is activated after a copy of their DEA certificate has been verified. Alternatively, activation codes may be sent via e-mail. On activation, addresses are recorded for each user's operational address. For a pharmacist, the DEA number of each pharmacy they operate out of are verified via checksum and recorded.

Registered doctors can initiate writing a prescription for a patient with the patient search function. Patients may be searched via first name, middle name, last name, date of birth, zip code, and/or last 4 digits of social security number. If the patient does not exist, an option to create a new patient is allowed. Once a patient has been created or selected, the doctor may enter multiple prescriptions for that patient. Drug names allowed are retrieved database call to insure data conformity. A diagnosis code may be required for each prescription written. Once the prescriptions are finalized, a unique verification code is randomly generated and presented for either transcription to a written or electronic prescription or to be vocally included for prescriptions being called in.

Registered pharmacists can verify prescriptions either called in or presented in written form by logging into the website and entering the unique verification code. In the rare incidence where there is a repetition for the unique verification, the pharmacist may be presented with patients for whom the verification code is valid. Once the pharmacist selects the correct patient that matches the verification code, they are presented with the complete prescription with options to either 1) fill the prescription as written, 2) fill for a reduced amount or 3) not to fill the prescription. Pharmacists may also enter payment method, typically the name of the insurer (pharmacy benefit manager or insurance company) or cash.

All HIPPA sensitive data and user passwords may be encrypted with AES or triple DES encryption or other encryption standards. IP addresses may be recorded for all transactions including user registration and all access to patient data is logged.

In particular, one embodiment of the present invention envisions a computer-implemented system for preventing prescription abuse. The system includes the steps of: receiving on the system a login request from a physician; verifying the identity of the physician; receiving on the system a patient history request from the physician; transmitting from the system the patient history requested in step c) to the physician; receiving on the system a prescription request from the physician; generating a unique prescription code from the patient history of step c) and the prescription request of step e); transmitting from the system the unique prescription code generated in step f) to the physician; receiving a system login request from a pharmacist; verifying the identity of the pharmacist; receiving on the system the unique prescription code from the pharmacist; and transmitting from the system the patient history of step c) and the prescription request of step e) to the pharmacist.

The system may include a secure web-based interface for the physician and pharmacist to transmit information to the system and to receive information from the system. Upon receiving the patient history, prescriptions identified by algorithm may be flagged by the system and presented to the physician. Additionally, or alternatively, if the physician believes the patient is abusing prescription medications, the physician may transmit a red flag warning to the system to be recorded in the patient's history to be viewed by future physicians. The web-based interface may include drop down menus containing medication information for the physician to select from.

The unique prescription code may be generated from information unique to the patient, such as their name, address, and/or birthdate, along with the prescription medication being requested. The unique prescription code may be generated in various forms, including but not limited to: barcodes, 2D QR codes, digital pictures, and alphanumeric codes.

After receiving the unique prescription code from the system, the physician is able to generate a prescription including the unique prescription code to send to a pharmacist. The prescription may take the form of a paper prescription or may be transmitted telephonically directly to the pharmacist. If the prescription is in paper form, it may be printed on tamper-resistant prescription paper. In particular, the tamper-resistant paper may be batched specifically for each physician with a unique sequential number for each page.

Additionally, as has been discussed, one benefit of certain embodiments of the present invention is the ability to generate and transmit the patient history and prescription request information to payors. By doing so, payors may be able to determine, at an early stage, patients that are abusing prescription medications and/or physician's that are recklessly over-prescribing medications to patients.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a flowchart depicting the steps performed in the systems and methods of the present invention for prescribing and filling medication.

### DETAILED DESCRIPTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

The present invention envisions a HIPAA-compliant, web-based system that allows physicians to monitor, validate, and verify prescriptions generated at the provider level and filled at the pharmacy level. By uniquely combining real time prescription information, a centralized provider database, tamper-proof prescription forms specific to each medical doctor, and the application of individual unique identifiers on every prescription, the system mitigates the risk of prescribing controlled substances. The patient risks include narcotic dependency, narcotic abuse, criminal prosecution for doctor-shopping, and overdose death. The medical provider risks include suspension or loss of the license to practice, and medico-legal, civil, and criminal litigation with possible prosecution for narcotic overdose and wrongful death. The Health Care System and Insurance Companies risk losing hundreds of millions of dollars paying for duplicate narcotic medications, excessive emergency room and urgent care visits, and needless hospital and Intensive Care Unit treatment days for narcotic overdoses.

To achieve these objects, it is envisioned that the system will utilize existing web-based technology whereby physicians and pharmacists may transmit and receive information to and from the system by logging in to a web-based system. The systematic approach is discussed more fully below in connection with the figures and a description of a particular embodiment.

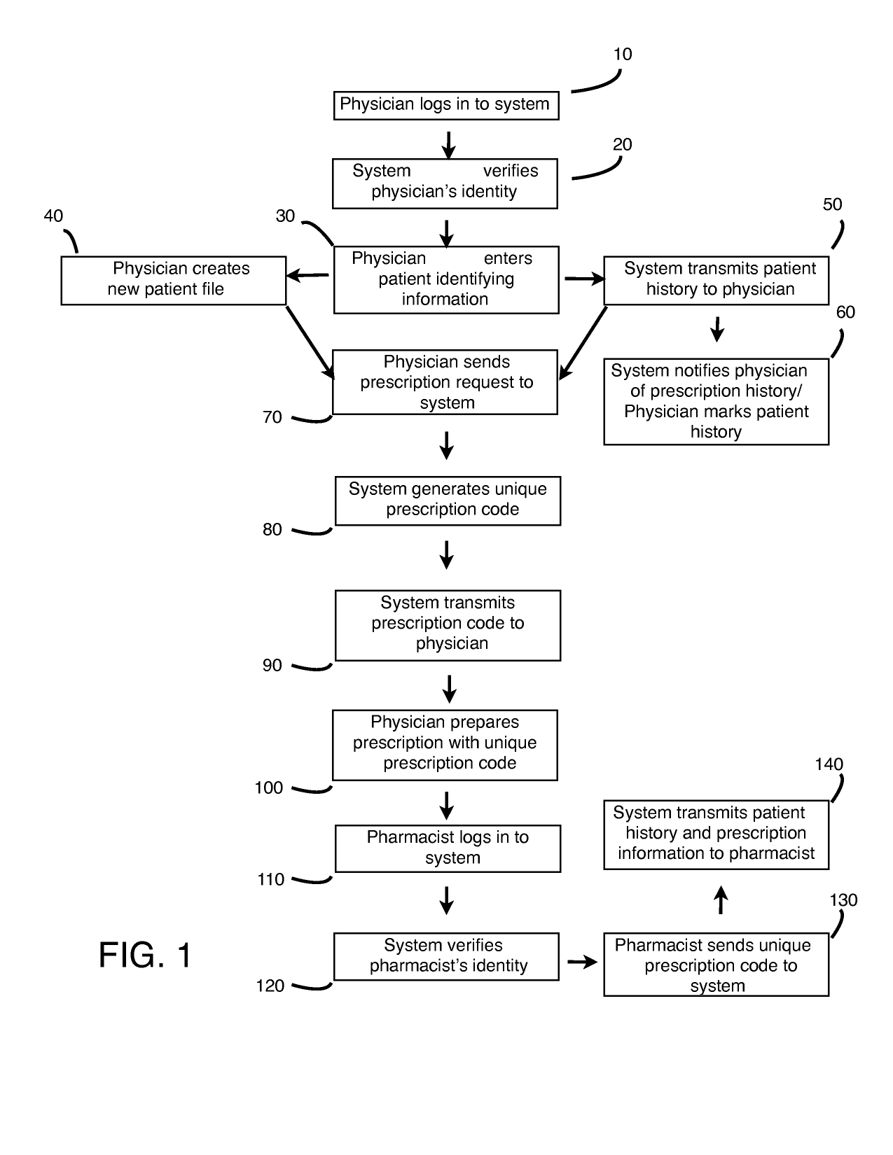

In that regard, FIG. 1 shows a flowchart discussing the normal steps taken by the physician and pharmacist in utilizing the system.

Initially the physician logs in to the web-based system in step 10 by entering identifying information. It is envisioned that after an initial registration login, wherein unique information about the physician is provided to the system, further logging in will be conducted via conventional security measures, such as user name and password protection, and other techniques readily known and practiced by those skilled in the art. The system then verifies the physician's identity in step 20 via the logging in procedure.

In step 30, the physician enters information in to the system to identify the patient for whom he or she desires to write a prescription. This identifying information may include information such as the patient's name, birthdate, address, social security number, insurance plan number and/or any other identifying information. If the patient is not already contained within the system's database, the physician will be prompted to create a new patient file in step 40. Assuming the patient is already within the system, the patient's medical history will be transmitted to the physician in step 50. The system's data collection includes the real-time capture of prescription information at the medical provider level. This includes the information of doctors, surgeons, dentists, podiatrists, and psychiatrists. Once a medical provider generates a prescription for a patient on the system, the information becomes immediately available to all other medical providers caring for that patient. Specifically, the prescription information for John Doe, with a date of birth of Mar. 14, 1973 living in St. Louis Missouri with a zip code of 63127 (and any other previous zip codes while treated) is only available to other medical providers caring for the same John Doe, with the same date of birth and at the same zip code(s). As such, based upon this real-time view of the patient's history, if the physician believes the patient is abusing prescription medication, the physician may mark the patient within the system with a red flag in step 60, to make future treating physicians aware of this. Additionally, upon receiving the patient history, prescriptions identified by an algorithm may be flagged by the system and presented to the physician in step 60 to assist in responsible prescribing.

After opening the patient file in step 50, the physician will enter all the necessary prescription information for the patient including the name of the medication, dosage, quantity of pills to be prescribed, route of administration, frequency of administration, and the patient's diagnosis code (reason for the prescription) in step 70. The medications may be retrieved from the Food and Drug Administration's national drug code directory; and as the physician enters the first few letters of the drug, an organized medication drop-down menu appears for the physician to select the medication they intend to prescribe. After selecting the medication, the provider is presented with choices of dosage and route administration. After selecting the dosage and route administration options, the provider enters the quantity of pills to be prescribed, frequency of administration, and the patient's diagnosis code.

Once all the information has been populated for each prescription in step 70, the physician has one more chance to review the prescription before saving the information to the system's database. Once the prescription has been generated by a licensed medical provider, the prescription is assigned a unique prescription code in step 80. This unique prescription code can be encoded in various ways such as the use of Bar Code, QR code, digital picture, or alphanumeric code. The preferred embodiment, however, is a scannable QR code. Once this unique prescription code is generated, it is transmitted to the physician in step 90. The physician may then prepare the patient's prescription, including the unique code, in step 100. Take for example, patient Elizabeth Jenkins, who has a date of birth Feb. 17, 1963, and who lives in Dana Point, Calif. with a zip code of 92629. At the time of prescribing for patient Elizabeth Jenkins, a unique prescription code is generated. This unique prescription code may be printed on the patient's prescription dated May 1, 2013 for 90 tablets of Norco 5/325 and 60 tablets of Lyrica 50 mg. Should Elizabeth Jenkins take this prescription to her local pharmacy to be filled, the pharmacist, after logging in to the system in step 110, and having his or her identity verified in step 120, can enter the unique prescription code contained on the prescription in step 130 and confirm that Elizabeth Jenkins was given a prescription for exactly 90 Norco 5/325 and 60 Lyrica 50 mg on May 1, 2013 in step 140. If for any reason, after the code is scanned, the digital image of the original prescription (on the pharmacists' screen) and the paper prescription do not match up exactly, it is clear that the prescription has been altered and should not be filled. In addition, if the code is invalid, it will easily be identified as a fraudulent prescription.

Once a patient's prescription information is entered into the system by a licensed medical provider in step 70, that information may be printed on secure, tamper-resistant prescription paper. This paper may be batched specifically to each provider, for all his or her patients. For example, John Smith M.D. practicing in Memphis, Tenn. could have prescriptions that, for example, start at 100-0000001; whereas, Jane Smith M.D. practicing in Irvine, Calif. could have prescriptions that start at 77-0000001. In this manner, every prescription filled at a pharmacy can be traced back to each individual licensed medical provider, irrespective of his or her practice location throughout the country. This protects both medical providers and pharmacists caring for divergent patients that cross state lines to fill narcotic and controlled medications. By utilizing the system, physicians are able to generate prescriptions and print them out on the above tamper-proof, batched prescription paper. This helps avoid pharmacy-related hand writing and transcribing errors at the time of fulfillment. Another security measure of the system may include the automation of prescribing. Physicians may not be able to free text prescription information, but rather must select an option from the Food and Drug Administration's national drug code directory (an imported list for proper dosages and strengths).

The present system is a novel combination of real-time prescription collaboration between licensed medical providers in the secure provider network across the United States, with a user-friendly, electronically generated and physician specific tamper proof prescription, and the application of a unique QR code that: minimizes prescription fulfillment errors, prevents doctor shopping and patient overdose, and saves Health Systems and Insurance Companies the unnecessary costs associated with duplicate prescriptions, emergency room visits by divergent patients, and hospitalizations for overdose.

In an effort to provide even greater prescription transparency, the system may allow licensed users to edit any changes to the fulfillment of the prescription. For example, if a new prescription that was generated by the system is not filled due to insurance, cost, side effect, or pharmacy issues, a licensed medical provider can update the prescription activity (or lack thereof) for that patient on the system. The update of prescription activity can be annotated at the pharmacy level if the prescription was not filled.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A computer-implemented system for preventing prescription abuse, the system comprising the steps of:
a) receiving on the system a login request from a physician;
b) verifying the identity of the physician;
c) receiving on the system a patient history request from the physician;
d) transmitting from the system the patient history requested in step c) to the physician;
e) receiving on the system a prescription request from the physician;
f) generating a unique prescription code from the patient history of step c) and the prescription request of step e);
g) transmitting from the system the unique prescription code generated in step f) to the physician;
h) receiving a system login request from a pharmacist;
i) verifying the identity of the pharmacist;
j) receiving on the system the unique prescription code from the pharmacist; and
k) transmitting from the system the patient history of step c) and the prescription request of step e) to the pharmacist.

2. The system of claim 1, wherein the physician and pharmacist transmit information to the system and receive information from the system via a secure web-based interface.

3. The system of claim 1, wherein step e) further comprises receiving on the system a red flag warning from the physician.

4. The system of claim 2, wherein the prescription request in step e) is selected from an identifying list of prescription medications.

5. The system of claim 1, wherein the unique prescription code in step f) is generated from the patient's name, address, birthdate and prescription request.

6. The system of claim 1, wherein the unique prescription code is generated in the form of a barcode.

7. The system of claim 1, wherein the unique prescription code is generated in the form of a QR code.

8. The system of claim 1, wherein the unique prescription code is generated in the form of a digital picture.

9. The system of claim 1, wherein the unique prescription code is generated in the form of an alphanumeric code.

10. The system of claim 1, wherein step g) further comprises the physician generating a prescription containing the unique prescription code.

11. The system of claim 10, wherein the prescription is transmitted telephonically to the pharmacist.

12. The system of claim 10, wherein the prescription is generated in paper form.

13. The system of claim 12, wherein the paper prescription is printed on tamper-resistant prescription paper.

14. The system of claim 13, wherein the tamper-resistant prescription paper is batched for each specific physician.

15. The system of claim 1, further comprising the step of transmitting the prescription request of step e) to a payor.

16. The system of claim 1, wherein step d) further comprises transmitting from the system a red flag warning to the physician.
